(19) United States
(12) Patent Application Publication
(10) Pub. No.: US 2002/0174059 A1
(43) Pub. Date: Nov. 21, 2002

(54) System for e-market management and global online cross-industry business integration

(76) Inventor: Yunbao Guo, Bronx, NY (US)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/153,507

(22) Filed: May 21, 2002

Related U.S. Application Data
(60) Provisional application No. 60/292,352, filed on May 21, 2001.

(51) Int. Cl. G06F 17/60

(52) U.S. Cl. 705/37

(57) ABSTRACT

An e-market management and global cross industry business integration system with models, structures, methods, and procedures creates and manages an e-market or supply network where any business or individual from any place in the world may participate in buying or selling of products and/or services, and in business collaboration with other with various degrees of involvement.

### CROSS-REFERENCE TO RELATED APPLICATION

This application claims the benefit of U.S. Provisional Patent Application No. 60/292,352, filed May 21, 2001.

### FIELD OF THE INVENTION

The present invention relates to e-market management and global online cross industry business integration that cuts across divisional-boundaries between and among different business units of a single diversified company, and/or between and among different corporations, and/or between and among different industries, and/or between and among different nations or regions from a business and information management perspective.

### BACKGROUND OF THE INVENTION

The emergence of Internet has caused a profound paradigm shift in modern business management. Individual businesses no longer compete against each other as solely autonomous entities, but rather as supply networks. Business management has entered the era of internet work competition. Instead of brand versus brand or store versus store, business competition now consists of suppliers-brand-store versus suppliers-brand-store or of supply network versus supply network.

The aggregator with the largest supply network will be able to offer the greatest number of options and most competitive pricing, thereby attracting the largest number of buyers, and as a result will increase its bargaining power over sellers. This phenomenon of increasing returns illustrates the significant advantages that large aggregators have over competitors. It also illustrates the potential for a supply network to be developed into a full-fledged e-market by leveraging its existing base of loyal buyers and sellers and by expanding its coverage into areas that surround and support it.

Traditional business models fail to address the compelling management issue: how to handle the increasingly complex interrelationships of a highly diversified company, a supply network or a global e-market. It is necessary, therefore, that we use our accumulated knowledge in business management and in information technology to creatively and systematically develop a new business management system with standardized and easy-to-follow models, structures, methods and procedures that align the interests of all participants, and that invigorate and streamline the interrelationships among all member companies.

The ultimate goal is to optimize an e-market by optimizing the performance of each of its commodities. When each commodity achieves its best performance, the e-market will reach its highest efficiency. This means that we shall leave no opportunity untapped. Everyone has to know everyone else in the market world and be able to trade or collaborate with it for goods and services in a highly efficient manner. To this end, we need to develop a core set of capabilities to handle the following objectives, among others:

1. To identify every type of commodity in terms of both its geographic characteristics and industry specifics in the world economy.

2. To rate the performance and desirability of each commodity through a competent and creditable agent.

3. To standardize and computerize routine business procedures to remove as much human factors as possible from the business process.

4. To break business tasks into the smallest processes to allow business collaboration at its simplest and most stable form.

5. To team together closely related member firms in or surrounding each commodity category to form a self-governed geocommodity (geographic commodity) group. Such a group will be in the best position to monitor and to rate the performance of its member firms.

6. Each of those self-governed geocommodity groups will in turn be monitored and rated by a higher-level geocommodity group or by the e-market.

7. To align the interests of all member firms in a special industry group by establishing a shared ownership structure and by promoting a unified group strategy.

8. To align the interests of all special industry groups within a specific region or high level industry by establishing a shared ownership structure for that region or industry, and by promoting a unified regional or industrial strategy.

9. To align the interests of all members, regions and industries by establishing a shared e-market ownership structure and by promoting a unified e-market strategy.

10. To assure that each part of the e-market will be managed by the best candidates possible.

11. To establish a highly efficient information management system that is capable of searching out every opportunity for every commodity in the system and to do business match-making among member firms worldwide at an unprecedented scale and with an unparalleled sophistication and thoroughness.

### SUMMARY OF THE INVENTION

A system of e-market management and global online cross industry business integration provides a Global GeoCommodity Identification System with multiple tiers and a complete set of commodity code and country code that specifies any type of product or service in any place in the world in a set of uniformed formats to identify every detail of an extremely complex global economy, and offers an essential commanding tool for massive computerized global e-market business and management process.

The present invention further provides a Unified Global Online GeoCommodity Umbrella Brand System that establishes a vital interface between the real world users and the non-human back end processing engine by following the same format logics of Global GeoCommodity Identification System, but by using real world names, such as the name of a country or region (a state, a city, a county or an area, etc.) and the name of an industry or a sub-industry as GeoCommodity Identification Elements, either combined or standing alone, to form an online GeoCommodity Umbrella Brand (GCUB) that is a real world equivalent of a GCIC in identifying a specific class of products or services, things or beings, in a specific country, or region, and/or in a specific industry or sub-industry.

Each GCUB represents a closely related business group with its own website and management body, and uses its own expertise to design and develop its own group strategies and membership polices concerning how its website or e-market segment should be operated and how member firms should be introduced to a worldwide clientele by using their own home-made rating system.

The present invention further provides a “Business Specialization and Business Standardization Model” that breaks business tasks into its smallest and most specific business processes by adding to a GCIC eight pieces of additional information to form a 53-digit character string with a multi-dimension information string architecture to describe a product or service's original location, industry classification, service area, service industry, performance rating and the performance rate of the respective rating agency (GCUB), production or service capacity, unit price and the nearest delivery time, etc., that forms the most basic and the most important information block in the system for high speed data process in an object oriented information management system.

The present invention further provides an Ownership Sharing and Business Delegation Model that aligns the interests of all participants by allocating equity shares to active members in the network based on their performance. Each participant remains its own boss runs its own specialized businesses (including its own websites) the way it wants, while also being able to collaborate with others in any field that makes strategic sense.

The present invention further provides an Ownership Sharing and Business Delegation Model that aligns the interests of all participants by allocating equity shares to members based on their performance.

The present invention further provides an Object Oriented Information Management Model that treats every entity or sub-entity as an object. Each object has attributes to encapsulate specific information within the object and methods to call other objects for related information and processing capabilities. The information system has replications in various regional processing centers around the world. Most of the replications are localized small versions of the system that are sufficient to run most of the local jobs while also being linked to major processing centers for jobs that they cannot process locally. The encapsulation of specific information within each specific object, the reusability of objects and the localization of information processing will greatly reduce the data load in the system and make massive data searching or data mining possible.

### DETAILED DESCRIPTION OF THE DRAWINGS

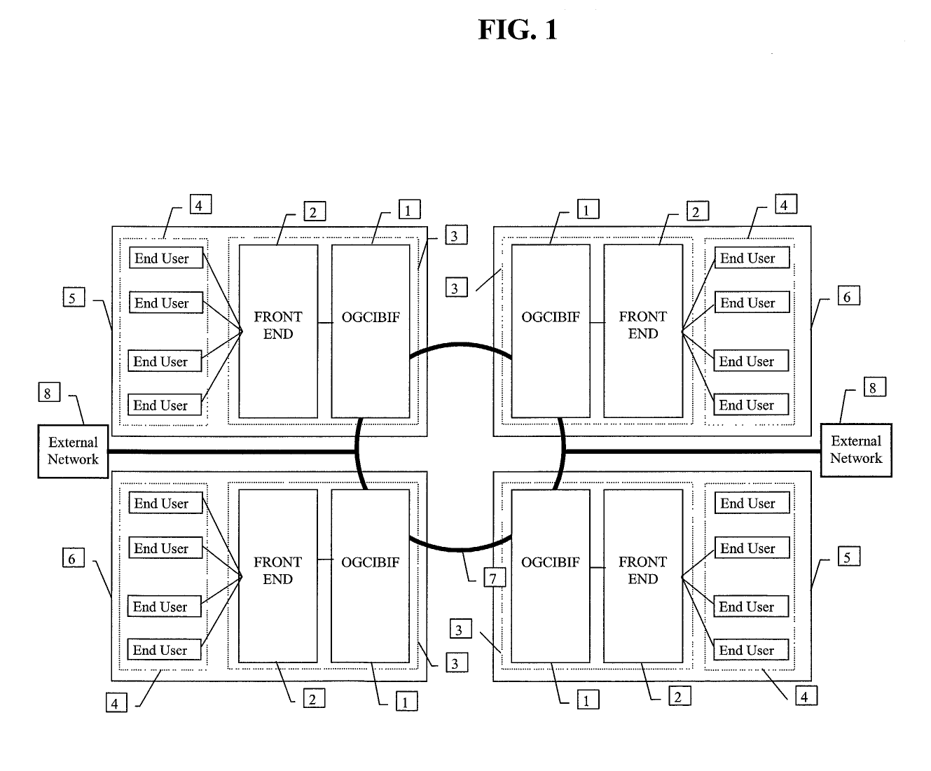

FIG. 1 depicts an overview block diagram of components of a System of E-Market Management and Global Cross-Industry Business Integration (SEMMGCIBI) according to the present invention and the relationships between and among the components.

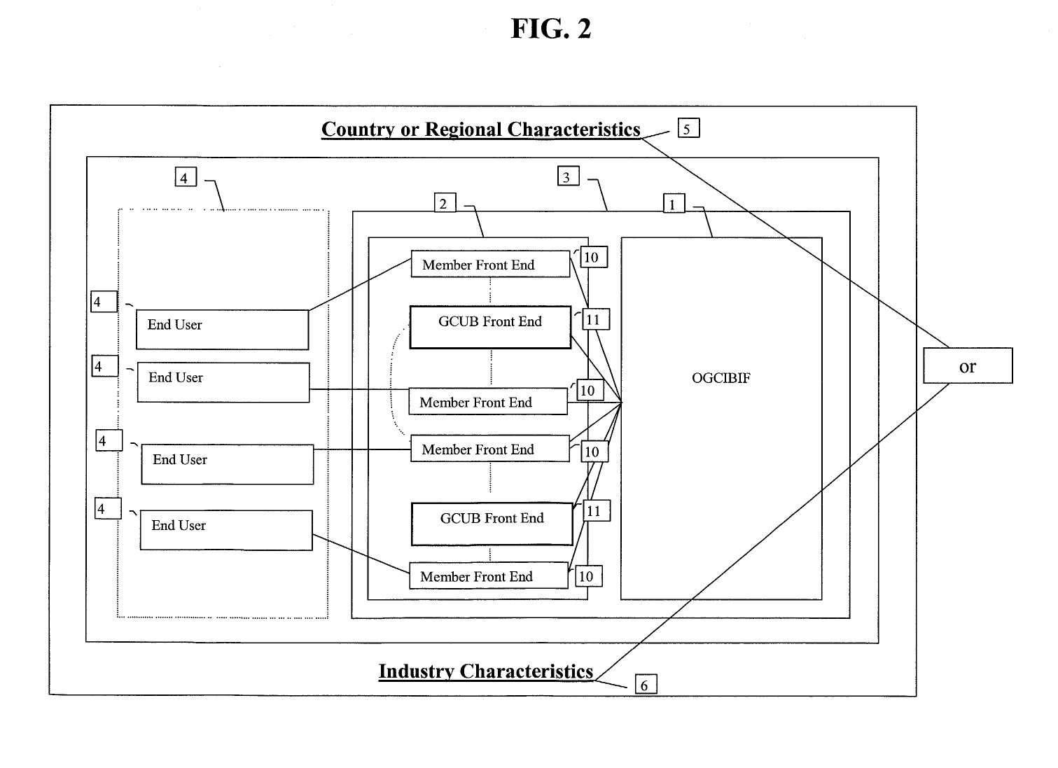

FIG. 2 depicts a block diagram of 5 (a country or regional trading block) or 6 (an industry trading block) from in FIG. 1, including types of front end presentation layers (web sites) and communication links between and among them.

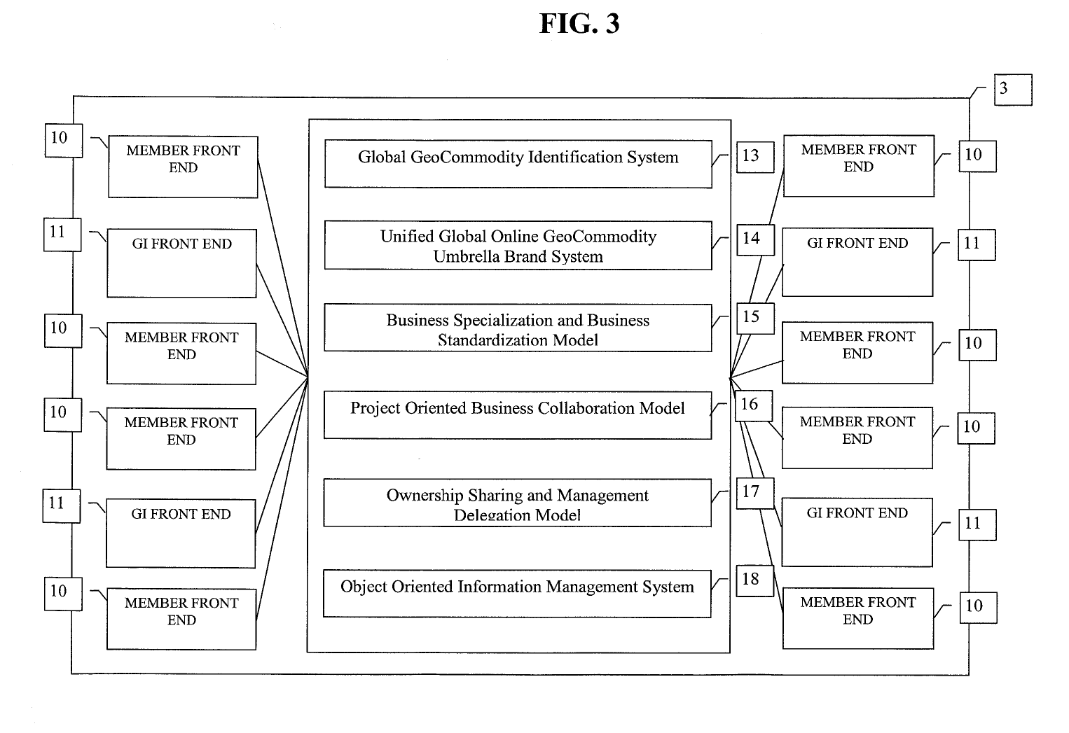

FIG. 3 depicts a block diagram of 3, a replicate of the System of E-Market Management and Global Online Cross Industry Business Integration (SEMGOCIBI) from in FIG. 1. Replicates of SEMGOCIBIs in different countries or locations may have different versions in order to reduce data load for most regional data centers.

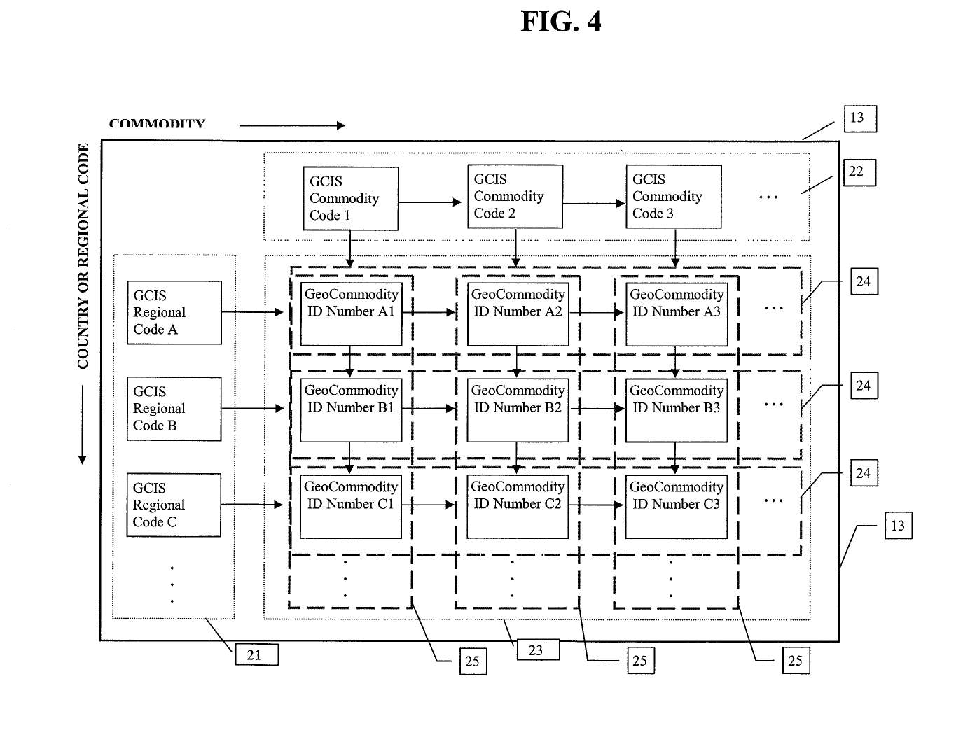

FIG. 4 depicts a block diagram of a Global Geocommodity Identification System (GGCIS), block 13 from FIG. 1, wherein block 21 is a complete set of country/or regional codes, block 22 is a complete set of industry/commodity codes, block 24 is geographic specific GeoCommodity ID Number group, block 25 is industry/commodity specific GeoCommodity ID Number group.

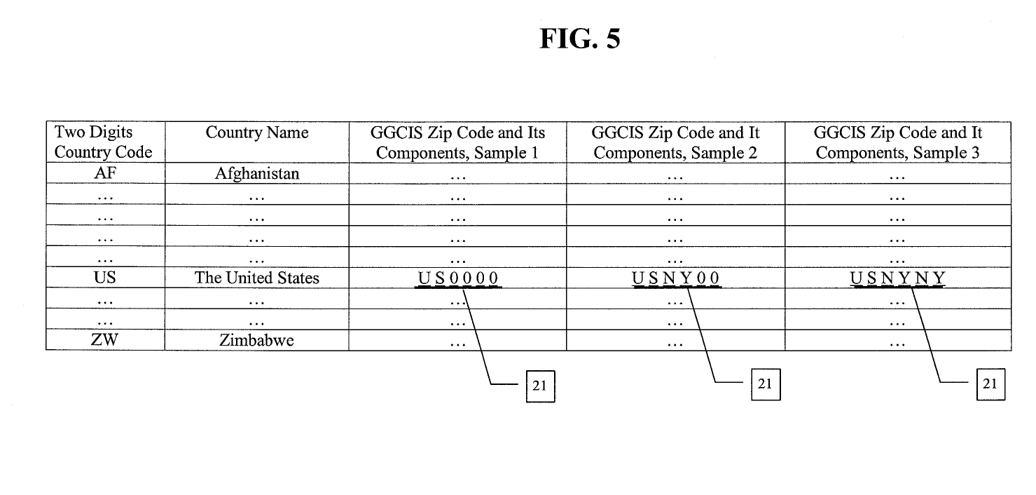

FIG. 5 depicts a GCIS Zip Code and Its Components showing a general GCIS code topology with three hierarchy elements to define a specific geographic area.

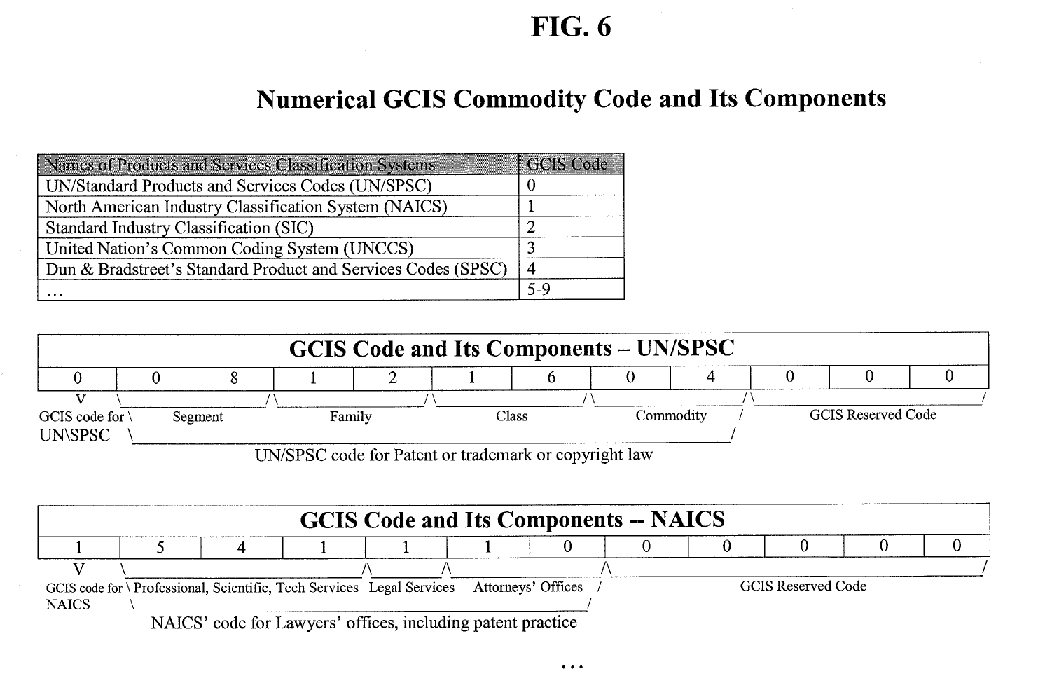

FIG. 6 depicts a general GeoCommodity Identification System (GCIS) code topology with UNSPSC and NAICS samples.

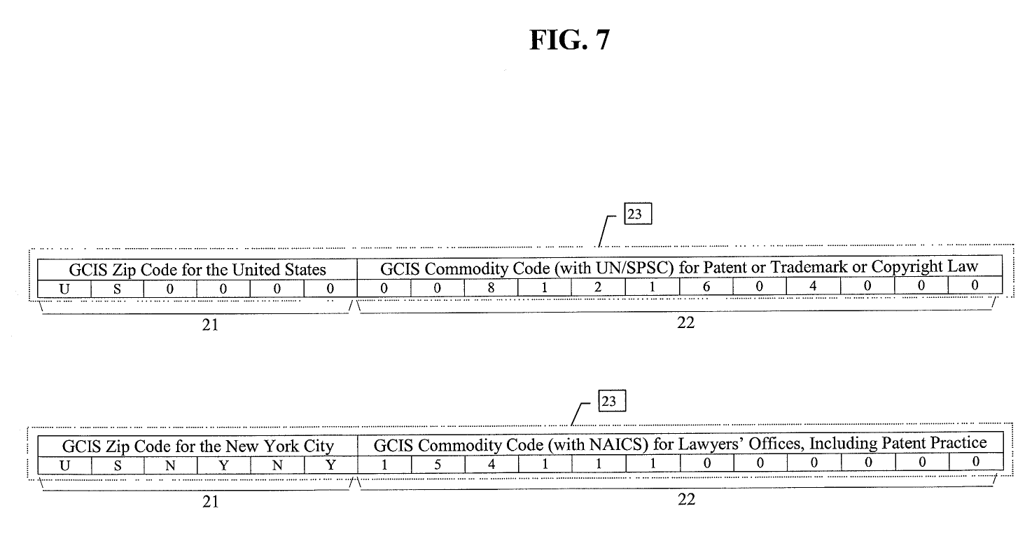

FIG. 7 depicts a Topology of Global Online GeoCommodity Identification Number and Its Components, showing the topology of a typical Global Online GeoCommodity Identification Code (GOGCIC) 23 of FIG. 4.

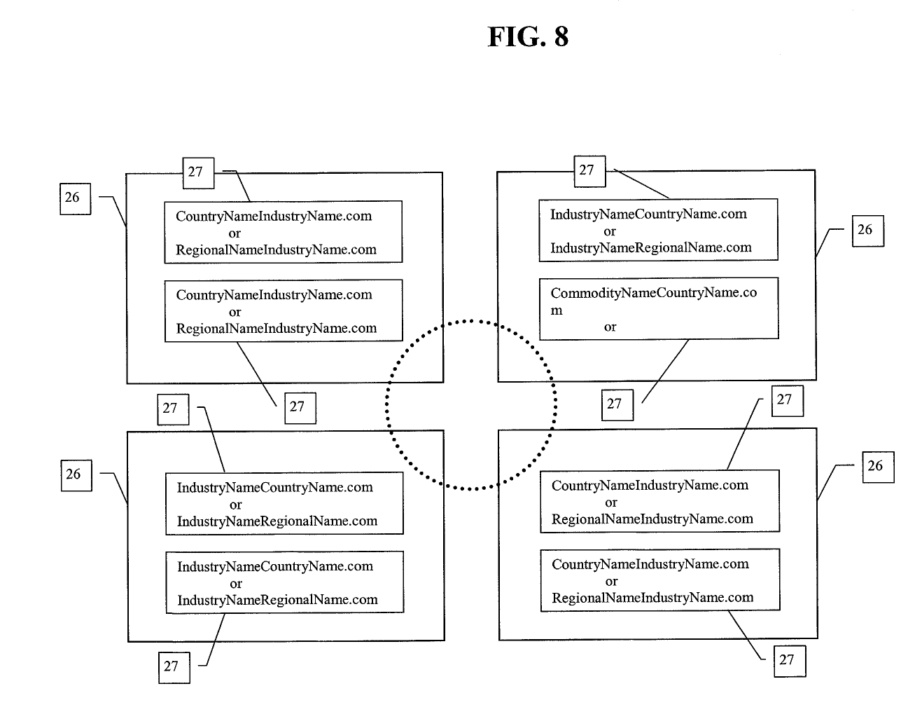

FIG. 8 depicts a Unified Global Online GeoCommodity Umbrella Brand Architecture (UGOGCUBA), with country/regional name+industry/commodity name brand topology 27, and a general industry/commodity name+country/regional name brand topology 29.

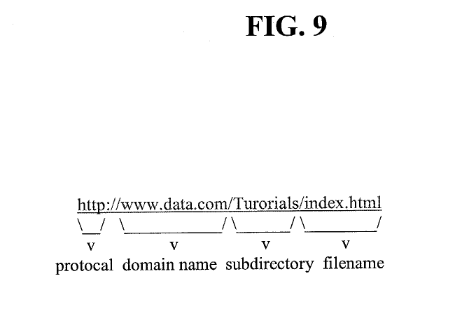

FIG. 9 depicts a typical DNS (Domain Name System) Hierarchy Structure.

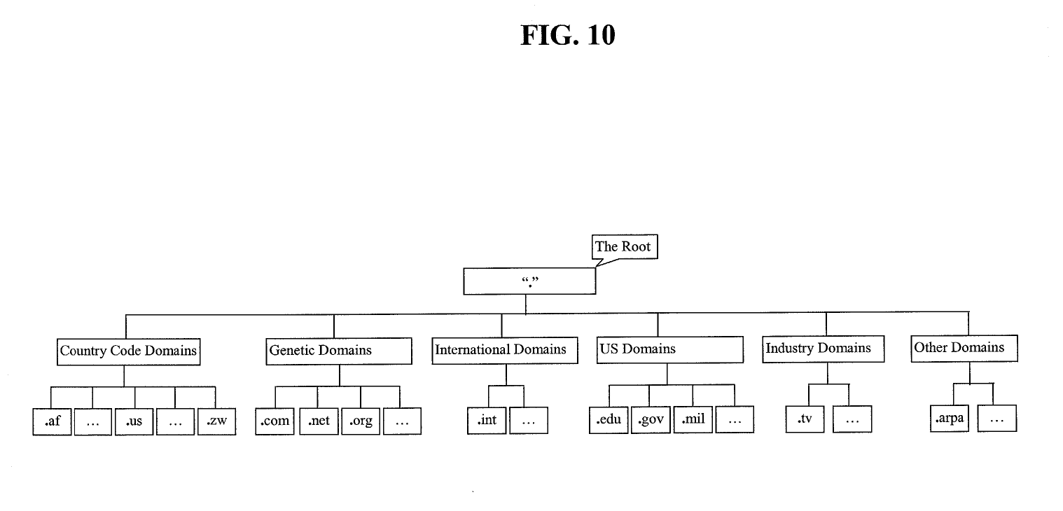

FIG. 10 depicts an evolving DNS (Domain Name System) Delegation Structure.

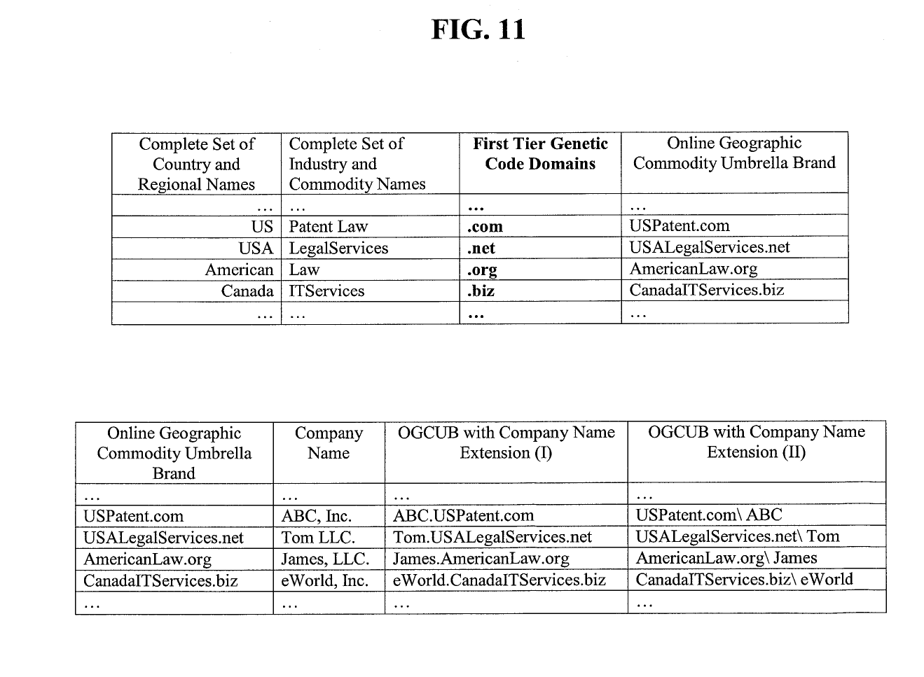

FIG. 11 depicts UGOGCUBA—every (a complete set of country/regional names) country/regional name+every (a complete set of industry/commodity names) industry/commodity name brand topology−with First-Tier Generic Code Domains and OGCUB with Company Name Extension.

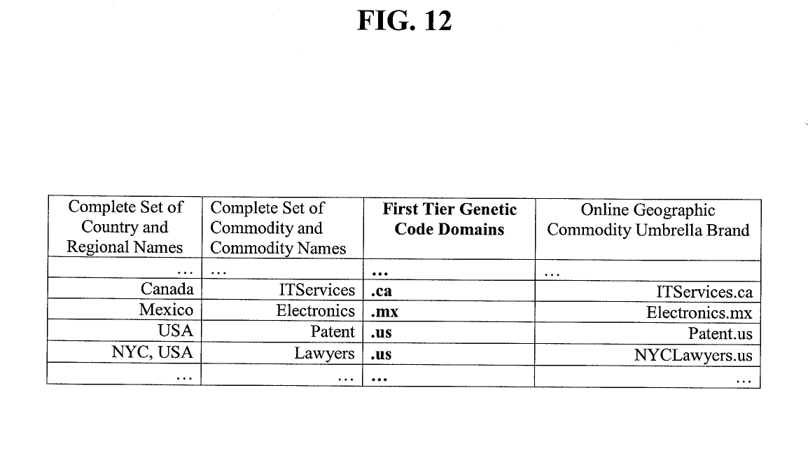

FIG. 12 depicts UGOGCUBA—every country/regional name (a complete set of country/regional names)+every industry/commodity name (a complete set of industry/commodity names) brand topology−with first-tier country code domains.

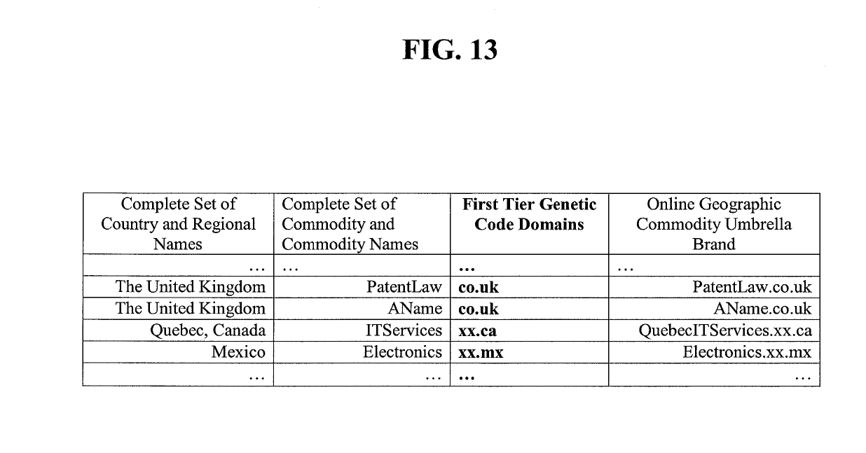

FIG. 13 depicts UGOGCUBA—every country/regional name (a complete set of country/regional names)+every industry/commodity name (a complete set of industry/commodity names) brand topology−with First-Tier Country Code Domains+Second Tier Generic Code Domains;

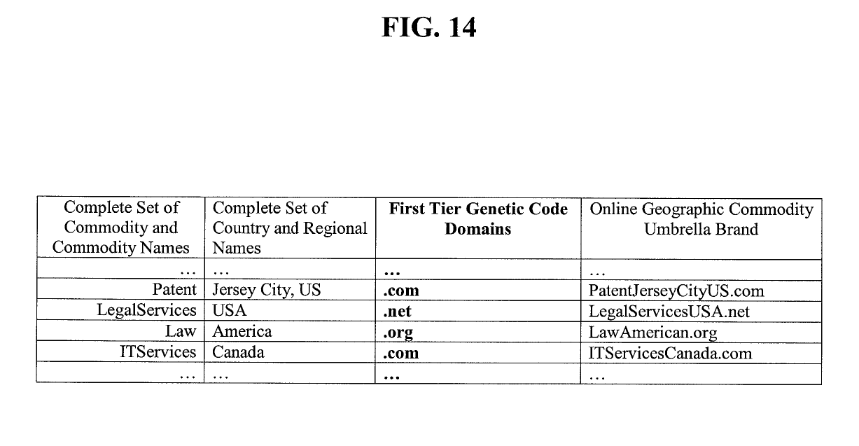

FIG. 14 depicts UGOGCUBA—every industry/commodity name (a complete set of industry/commodity names)+every country/regional name (a complete set of country/regional names) brand topology−with First-Tier Generic Code Domains;

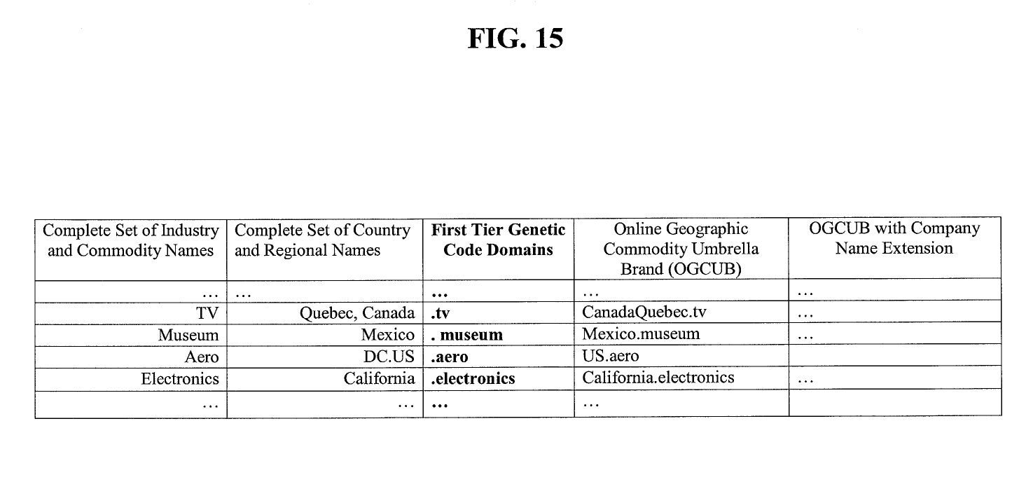

FIG. 15 depicts UGOGCUBA—every industry/commodity name (a complete set of industry/commodity names)+every country/regional name (a complete set of country/regional names) brand topology−with First-Tier Industry/commodity Code Domains);

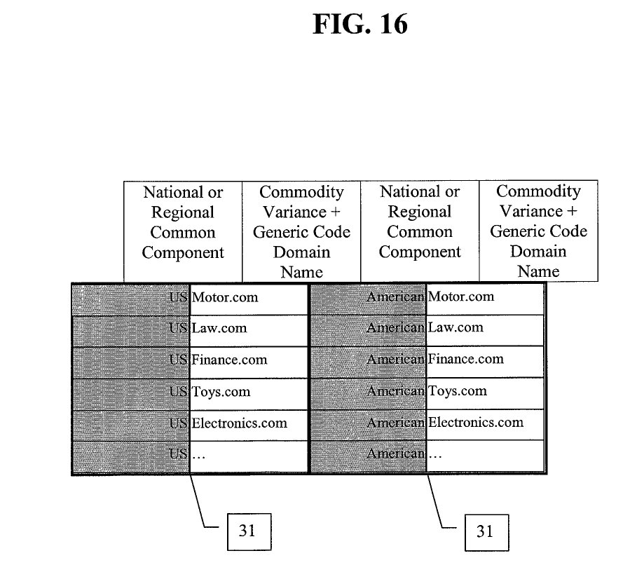

FIG. 16 depicts UGOGCUBA−CountryName+IndustryName topology, with First-Tier Generic Code Domains;

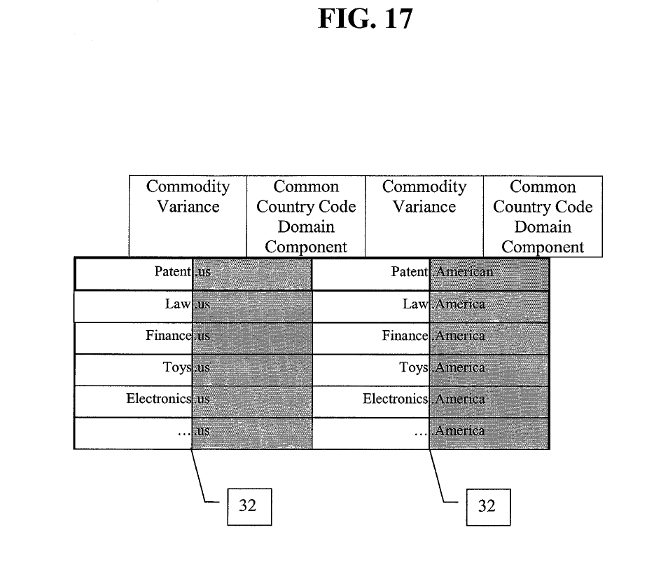

FIG. 17 depicts UGOGCUBA−CountryName+IndustryName topology, with First-Tier Country Code Domains;

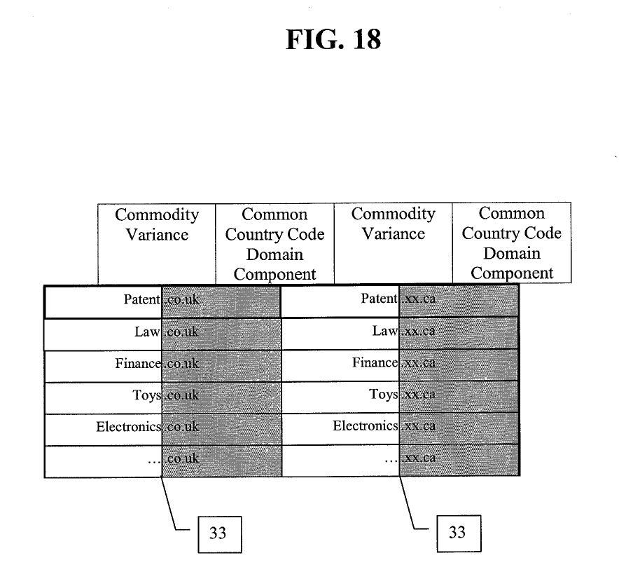

FIG. 18 depicts UGOGCUBA—CountryName+IndustryName topology, with First-Tier Country Code Domains +Second-Tier Generic Code Domains;

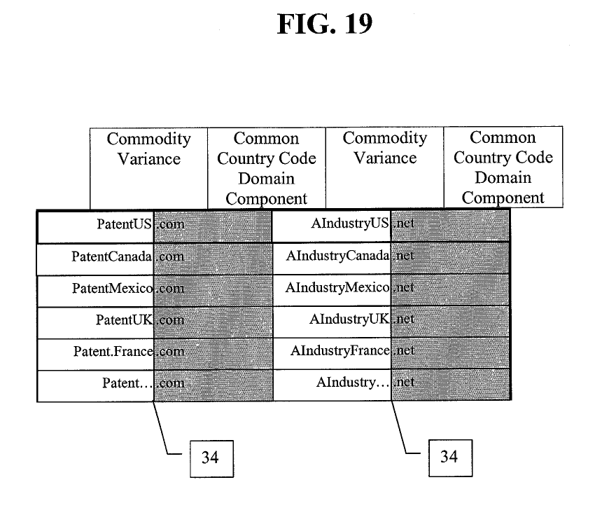

FIG. 19 depicts UGOGCUBA−IndustryName+CountryName topology, with First-Tier Generic Code Domains;

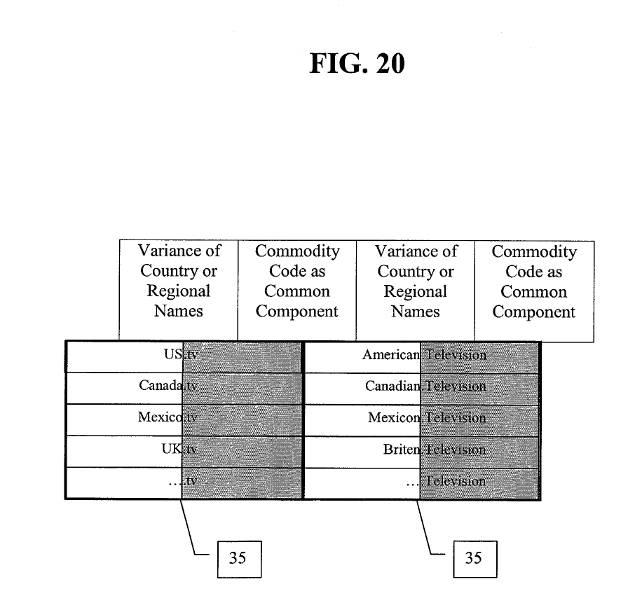

FIG. 20 depicts UGOGCUBA−CountryName+IndustryName topology, with First-Tier Industry/Commodity Code Domains;

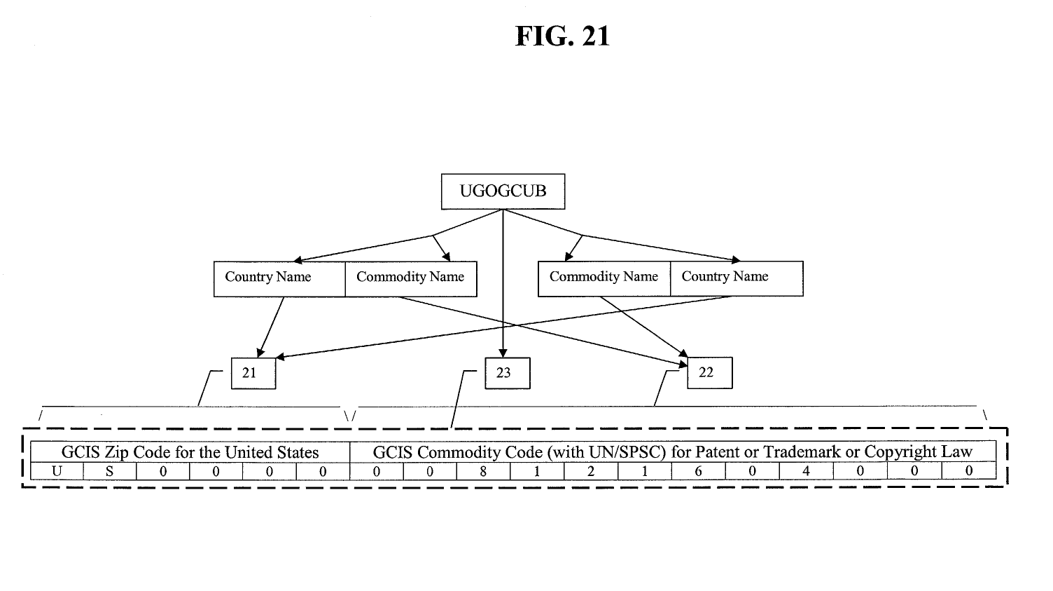

FIG. 21 depicts a general method of mapping (Unified Global Online GeoCommodity Umbrella Brands (UGOGCUB) to GeoCommodity Identification System (GCIS).

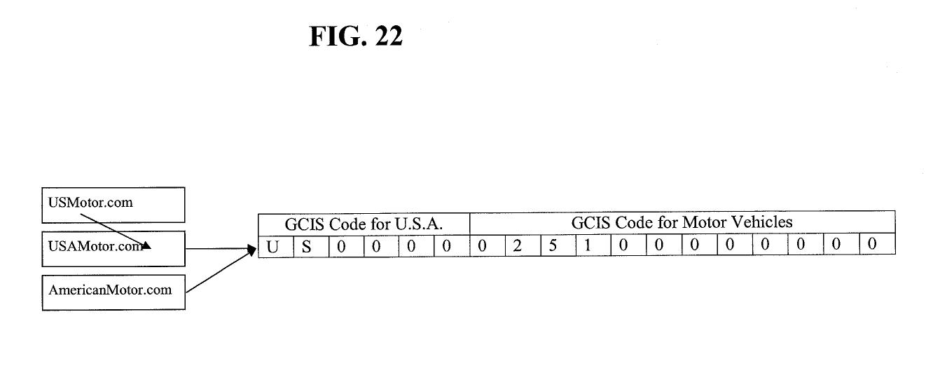

FIG. 22 depicts “many to many” relations between UGOGCUB and GCIS code, in the diagram, many UGOGCUB codes point to the same GCIS code.

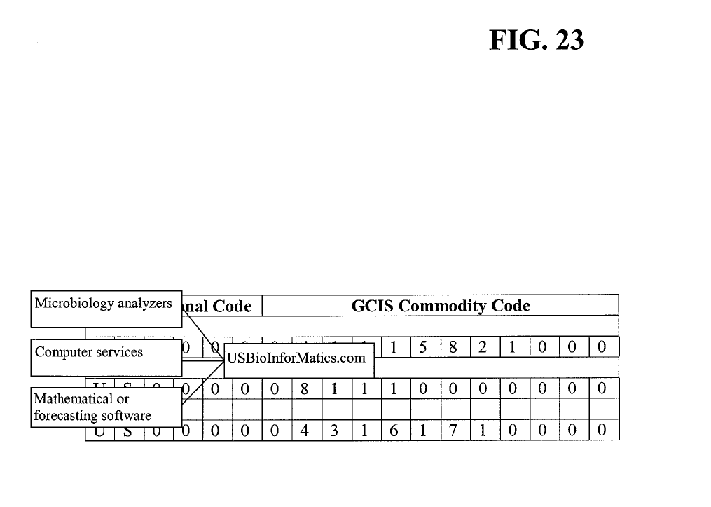

FIG. 23 depicts “many to many” relations between UGOGCUB and GCIS code, in the diagram, many GCIS codes point to the same UGOGCUB code.

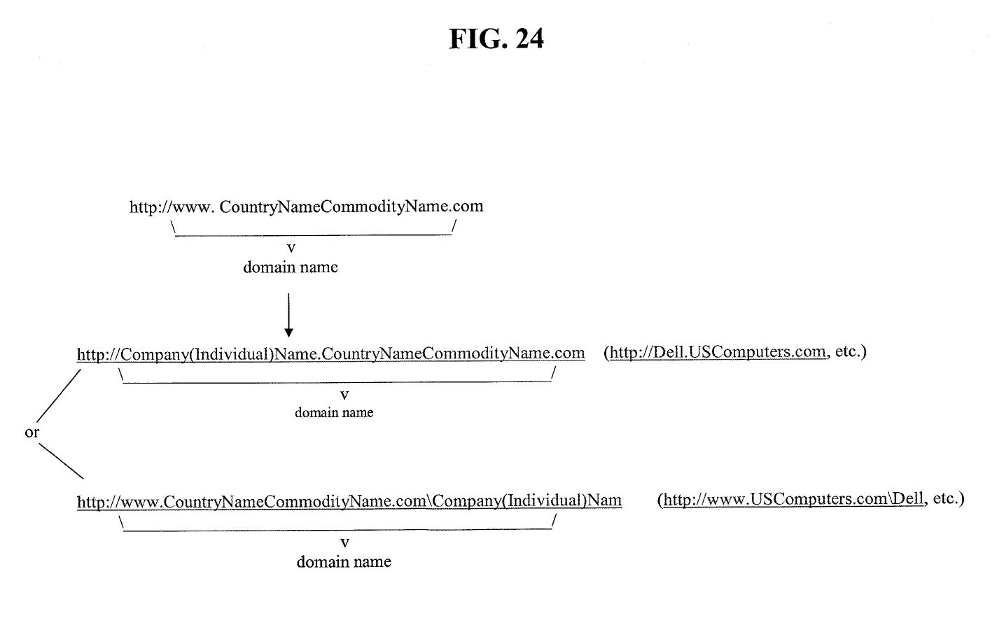

FIG. 24 depicts UGOGCUB extension topology, with Variant Extensions to identify any business or individual on the planet.

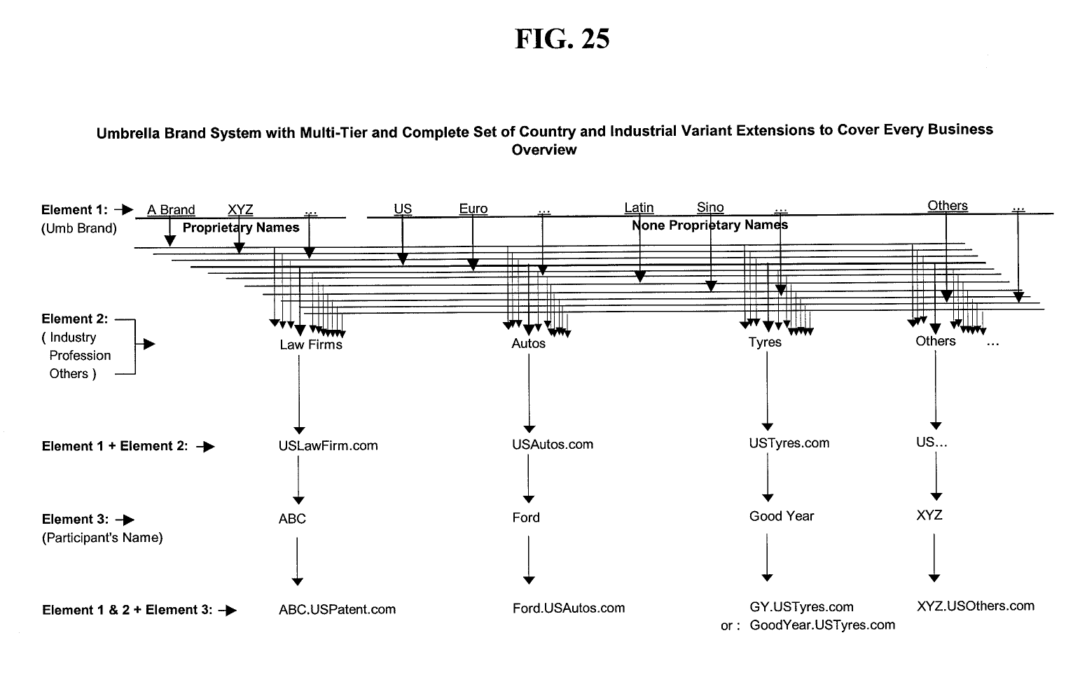

FIG. 25 depicts an overview of the Umbrella Brand System with Multi-Tier and Complete Set of Geographic and Industrial Variant Extensions to Cover Every Business.

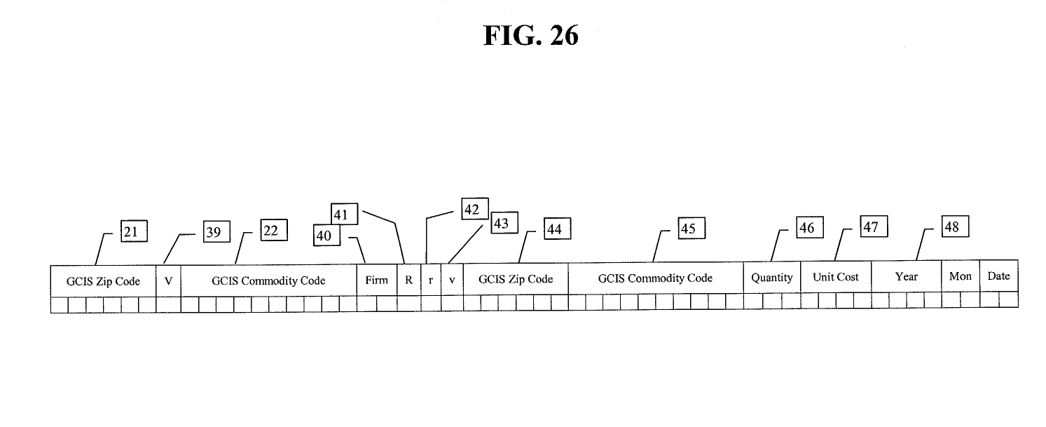

FIG. 26 depicts a multi-dimension information string architecture with a sample Global Online GeoCommodity Specification Code.

### DETAILED DESCRIPTION OF THE INVENTION

Just as Eskimos have a dozen different words to describe snow, each indicating a different degree of impact that the snow has on their lives, we in a global e-market also need different words to describe commodities made in different geographic locations. For example, while a pair of shoes made in Italy shall be labeled as ItalianShoes (technically without space between characters for efficient computer process), a pair of shoes made in Cuba shall be labeled as CubanShoes. They are different not only in quality, style, freight cost, etc., but also in the fact that a buyer's country may have import restriction on one of the two countries that might deem one of the two commodities inconsumable and/or economically unacceptable. It is necessary, therefore, that an e-market be able to identify every commodity in terms of its geographic origin.

The present invention solves this issue by providing a Global GeoCommodity Identification System, shown in FIG. 4, that arranges a complete range of country or regional codes along one direction of the diagram, either vertical or horizontal, and a complete range of commodity codes at the other direction. Each country or regional code will cross each industry code once on the diagram to create a geocommodity cross point. A combination of the country or regional code, such as GCIC Zip Code “A” shown in FIG. 4, with the commodity code, such as GCIC Commodity Code “1” at each geocommodity cross point will form a geocommodity identification code, such as “A1”, that uniquely identifies every geocommodity in the world economy. Together, those geocommodity identification codes constitute a powerful commanding tool that is able to identify any commodity in any place in the world in a highly concise fashion.

With regard to the level of differentiating a commodity, a geographic area, a type of thing or being, it shall be a function of the manageability of the object. For example, it may be desirable to differentiate the object “Shoe” into “Casual Shoes”, “Dress Shoes”, and “Athletic Shoes”, etc., because of the large number of product varieties that “Shoe” has, but not to further differentiate an object like “glove” since the number of product varieties for “glove” is relatively small and manageable. It may be desirable to differentiate the object of “New York City” further into “Manhattan”, or “Lower Manhattan”, because of the economic significance that “Manhattan” or “Lower Manhattan” has, but not to differentiate the object of “Fiji”, since the economic complexity of Fiji is relatively low and manageable.

Each of the country or regional codes at one direction of the diagram represents a country or regional object. Each of the industry codes at the other direction of the diagram represents an industry object. Each country has its own rules, regulations and country characteristics that should be identified and encapsulated within the country or regional object. Each industry has its own standards, qualifications and industry characteristics that should be identified and encapsulated within the industry object.

Each country object or industry object could be further differentiated to lower level objects, such as the object of a state, city, county, area or sub-industry to identify and encapsulate the specific characteristics of that specific group. The country or regional object, the industry object, and the sub object of a country, or regional, or industry object could be referred to as needed when we deal with specific commodities within each of these groups.

With regard to country code, the United Nations has a set of two-digit letter codes for every country in the world. We also have a two-digit code for major cities in global telecommunication.

With regard to commodity or industry code, the United Nations has a set of 8-digit coding system, called UNSPSC (United Nations/Standard Products and Services Codes) to classify products and services around the world. The United States also has a set of 4-digit classification codes, called the U.S. Standard Industrial Classification (SIC). The SIC has now been replaced by a new 6-digit coding system, developed jointly by the U.S., Canada and Mexico, called the North American Industry Classification System (NAICS). There are still other industry or products and services classification systems in the world.

One of the problems with those systems is that they are incompatible. Another is that they are slow in catching up with the rapidly changing industry landscape. New products and services are emerging on daily basis and that is not reflected in these coding systems quickly enough.

To deal with this problem, the present invention uses an 11-digit Global GeoCommodity Identification System (GGCIS) that can accommodate the use of any of those industry or commodity classification systems (the 8-digit UNSPSC has the longest unit code) on the market (see FIG. 6). The first letter of the 11-digit code indicates which coding systems is to be used with 0 (by default) standing for the UNSPSC, 1 standing for NAICS, 2 standing for SIC, etc. The next eight digits are used to take in the code from one of those systems. The last two digits are GGCIS reserved spaces to be used to quickly identify any new product or service that member firms claim. Any newly created code will be dropped automatically if not actively used for a certain period of time.

However, whereas codes are concise and highly efficient for computerized business processes, they are incomprehensible in the real world. To deal with real world human beings, we need to use descriptive words and to develop strong brands as a presentation layer that is able to communicate back with the back-end engine for any business request that it receives for processing. Hence, in the next subject, we discuss a Unified Global Online GeoCommodity Umbrella Brand System.

The present invention further provides a Unified Global Online GeoCommodity Umbrella Brand System, that establishes a vital interface between real world users and the inhuman back-end processing engine by using generic names such as the name of a nation, and/or region (a state, a city, a county or an area, etc.) and/or the name of an industry, and/or a sub-industry as GeoCommodity Identification Elements, either combined or standing alone, to form an online GeoCommodity Umbrella Brand (GCUB), a DNS (Domain Name System) domain, such as “USPatent.com”, or “Patent.us”, or “US.patent”, etc., that is general enough to identify a whole class of products or services, things or beings, especially in a specific country, and/or region, and/or industry, and/or sub-industry (see FIG. 8, Unified Online Global GeoIndustry Umbrella Brand Architecture−Country [or Regional] Name+Industry Name Formula).

Using DNS (Domain Name System) names instead of numerical IP addresses to reference remote hosting server is a giant step forward in transforming the Internet from a network platform to a networked market platform. A meaningless website address suddenly turned to be an online brand that is more important than what a brand could be in traditional sense (see FIG. 10). FIG. 10 depicts an evolving DNS (Domain Name System) Delegation Structure. At the left hand side, the first block depicts the country code domains with a two-digit code for every country in the world. The second block depicts a generic domain block with an expanding range of generic domains. The fifth block depicts an expanding industry/commodity domains block.

In pre-Internet days, a brand always had a visual component. While the name was the most important element, the visual component also influence the brand's purchase. Examples of such visual components include the shape of a Coca-Cola bottle, the colors on a box of Kodak film, the typography of an Intel logotype, the look and location of a McDonald's restaurant.

By contrast, accessing the Internet does not involve the visual component. In order to tap into a Website, you type in a word. No pictures, no colors, no typography, no look, no location. Your name stands alone, and is your most important corporate property.

A website address (Uniform Resource Locator or URL) is typically of the form http://www.aname.com, where “www.aname.com” is the DNS name (see FIG. 9, Typical DNS [Domain Name System] Hierarchy Structure). As is well known, domains are what an organization or legal person registers through accredited registrars, such like “directnic.com”, “register.com” for the right of usage currently on a “first come, first served” basis. The perception that a shorter name is a better name has led to intense pressure towards the root of the name hierarchy (See FIG. 10, The DNS Delegation Structure) for a broader set of short domains outside of the national country codes.

We now have “.tv”. We could also have “.it” (for Information Technology). We now have “.info”. We could also have “.auto” (for the automobile industry).

Further, we could have a specific domain for each specific industry in a specific country or region, in the form of “idustryName.CountryCode”, such as “.it.uk”, or in the form of “CountryName.IndustryName”, such as “uk.it”, to reference the information technology industry in the United Kingdom.

While there are advantages to the idea, the argument for not rushing into it is strong: a majority of the domain names currently registered are not utilized. Most of the two-digit country code domains are not even activated. At the root of the issue is really the fact that there is not yet an effective strategy for utilizing our cyberspace.

The Unified Global Online GeoCommodity Umbrella Brand System of the present invention meets the challenge head on by offering a structured, systematic and holistic online branding architecture that aims at creating a unified branding system to cover the entire world economy by establishing one umbrella brand for each of its market segments in a standardized and uniformed format for developing and operating an open e-market network system where everyone from anywhere in the world may take a part as an equal partner.

The Unified Global Online GeoCommodity Umbrella Brand System uses a complete set of generic geographical and industrial names, as opposed to the traditional way of using proprietary names, such as the name of countries/regions, states, cities, etc., and the names of industries, commodities, etc., and weaves them into a whole range of patterned GeoCommodity Umbrella Brands (GCUBs)—domain names. Each GCUB designates a specific commodity that is of a specific geographic origin. The GCUBs are collectively complete and collectively unique in covering the entire world economy and marketplace.

The need for using a generic name as an umbrella brand to unify a whole class of products or services, things or beings as a group, the need for using a whole range of structured and descriptive geocommodity names to form an umbrella branding system to unify all classes of products or service, and all things or beings as a common e-market, or supply network, are evident when we look into the troubled interrelationships between and among buyers and sellers, or clients and agents, between and among peer-to-peer corporate business partners, and between and among peer-to-peer business units within a single diversified company, as illustrated in the following three case studies:

A) Conflict of Interests Between Buyers and Sellers or Clients and Agents

Automated Website Creation and Maintenance Service (AWCMS) helps small and medium-sized companies, and professionals, establish an online presence without having to spend a fortune. Participants can login to a service provider's website, enter or upload their business information, answer a few questions, and then a website will be created for them automatically the way they want. A well-developed “AWCMS” with e-commerce capabilities can further help companies significantly improve their operational efficiency through the automation of key business processes and through the ability to identify and make deals among all affiliated businesses.

Because AWCMS is a service that, once it is set up, adding to it in hardware and administration cost is pretty minimal, a service provider could offer it to clients largely free or at very low fee schedule. It is a great way for an e-market integrator to attract a large number of new users and to cultivate a critical mass of royal sellers and buyers.

This powerful service model, however, does not score well in the marketplace. The problem is that whenever a participant needs to create a website through an “AWCMS,” it either has to have its own domain name or it will end up using the service provider's proprietary domain name.

In order to use its own domain name, a participant needs to have a domain name that it likes and that is still available to the participant for registration. The participant will have to bear the burden of marketing a standalone website to a worldwide clientele.

On the other hand, if a participant uses the service provider's proprietary domain in the form of “ClientName.HostName.com,” or “HostName.com/ClientName,” it will result in a loss of the participant's own identity and confusion. This conflict of interests between clients and agent stands as a roadblock to the two parties for building a mutually beneficial business relationship.

B) Incompatibilities Between and Among Business Partners

Mergers and acquisitions can help companies fill holes in a product line, open new markets and create new capabilities in less time than it would take to build businesses internally. Yet, numerous studies have shown that mergers and acquisitions destroy value for the acquiring company at least half of the time.

Most often, the difficulties arose from the failure to integrate the acquired business in time or at all. A highly diversified portfolio of businesses tends to end up becoming a welter of uncoordinated projects that confuses customers, aggravates interrelationships among business units and possibly result in action gridlock.

C) Uncoordinated Business Units of Highly Diversified Companies

Strategic alliance joins companies in a common cause. Yet, as business environment changes, so do corporate goals. What is good for a company today may not be good for the same company tomorrow. Incompatibility of corporate management styles is another key factor that drives partners to divorce. It is not surprising that about 55 percent of business partnerships break up within three and a half years.

The rate of failure is even higher (at 61 percent) when strategic alliances involve companies headquartered in two or more countries. While partners in a global strategic alliance are usually more sophisticated, the challenges that they face are also greater because of the dissimilarities in societal culture, national context, corporate culture, strategic direction, management practices and organizational structure. There is no proven business model that can be widely applied to various business partnership deals.

The solution solves the above problems by establishing an online structured multi-tier umbrella branding system with a complete set of country and industrial variants that covers any business (including, but not limited to, those listed in the UNSPSC, NAICS, SIC, etc.), at any place in the world.

FIG. 11 depicts one preferred embodiment of an organizational structure of multi-tier, complete set of geocommodity umbrella brand system. FIG. 11 depicts UGOGCUBA—every (a complete set of country/regional names) country/regional name+every (a complete set of industry/commodity names) industry/commodity name brand topology−with First-Tier Generic Code Domains. In this example, an umbrella brand combines two geocommodity elements to designate a specific geocommodity. The protocol of “USPatent.com”, for example, composes of a first (US), second (Patent), and third element (.com). The three elements are used to define the scope of the business as it relates to the economy. The second diagram on the page depicts the topology of further carrying OGCUB to lower level with company or commodity names, for example, to narrowly define a business, or commodity, or thing, or being.

With a whole range of geocommodity umbrella brands, such as “USPatent.com”, “USComputers.com”, “USMotors.com”, and “USToys.com”, etc., an AWCS provider would be able to meet any client's need for a domain name. For example, if a patent law firm called ABC, LLP wants to create a website through an AWCS provider, that patent law firm may well have a domain name like “ABC.USPatent.com.”

The “USPatent.com” element suggests a patent law firm in the U.S., while the “ABC” element specifies that this U.S. patent law firm is “ABC”. By having its own name “ABC” as a prefix to an otherwise suggestive generic name “USPatent.com,” the client firm, “ABC” retains its own identity and brand. Thus, the present invention solves the problem of Case Study (A), The Conflicts between Clients and Agents.

In certain embodiments, more than three elements can be used to narrow the umbrella brand to a more specific sector of the economy.

The first element is the umbrella brand, which can be the name of a country, state, industry, profession, characteristic, race, religion or proprietary name, such as a brand name. For example, a character string, such as “US” or “Euro,” can be used to suggest a country or a region (see FIG. 12). A character string, such as “tv” or “museum,” can be used to suggest an industry or profession. Moreover, a character string, such as “Latin” or “Sino” can be used to suggest race. A character string, such as “Top” or “Royal” can be used to suggest a quality or character.

It is preferred that the umbrella brand be one that has many differentiated variants within its larger category such that it carries meaning by itself. A country designation, such as a two-letter code, would be preferred. However, as discussed further, many other umbrella brand designations may be used.

Beyond the umbrella brand, further elements or tiers break down the industry more narrowly. The second element is an industry variant extension, e.g., extensions that pertain to a specific marketing niche. This could be an industry, a profession, a being or a thing.

The third element is the Participant's name. This can be any character string that uniquely defines the participant. For example, “Ford,” “GoodYear,” or a law firm name can be used.

A combination of one first element and one second element defines a group umbrella brand and/or a domain name. The group umbrella brands and/or domain names are in the format of “UmbrellaBrandlndustryName.com.” For example, “USLawyer.com,” “USAuto.com,” or “USCitizen.com” are group umbrella brands and/or domain names.

Moreover, the group umbrella brand and/or domain name can be further combined with the third element to form a specific brand name or a specific domain name. By combining the group umbrella brands with an industry designation, a new word is generated that designates a specific industry or profession, a specific type of product or service or a specific type of being or thing that is memorable and personalized.

With the complete set of domain names illustrated in FIGS. 11-15, a provider could meet clients' needs for any domain name.

The system described herein is a structured, systematic and holistic system and with a preset strategic goal of covering the entire global e-market by establishing a multi-tiered structure of geocommodity elements and sub-elements that cut across all business, industry, service, personal and geographic boundaries. This is compared to the traditional, random system of organizing businesses in web addresses, each of which targets a single individual or company within a specific industry or service, a single type of product or service, or a single type of thing or being.

This system enables a planned, systematic and large scale approach aimed at creating a whole range of industry variant designates, each linked to a specific industry or profession, a specific type of product or service, and a specific type of thing or being, to achieve the collectively completeness and the collectively uniqueness in identifying an entire economy or market. Each domain must consist of at least two distinctive elements: a word that designates a distinctive industry or profession, a distinctive product or service or a distinctive thing or being, and a word that is to be used as an umbrella brand for the multi-tier and complete set of industrial designations (domains.).

Further elements or tiers can be added in order to more particularly subdivide the industry, as needed or desired. However, as more elements or tiers are added, the domain name or address becomes inherently less valuable.

The result is a unified umbrella brand that shines over a whole range of distinctive but closely interrelated business entities across all kinds of industry boundaries, and not a system of single, unrelated web addresses or brand names as is currently done. By contrast, currently, random domain name registrations are given for individual names, and names can be any words or word combinations.

The present invention achieves collective completeness and the collective uniqueness in identifying the entire world economy or marketplace (with the top level domain, such as “.tv”, “.auto”, “.pc”, etc., or with second level domain names such as “worldtv.com”, “worldauto.com”, “worldpc.com”), or a specific economy or market (with second level domain such as “USTV.com”, “USAuto.com”, “USPC.com”, etc.) by a planned, a systematic and a large scale approach aimed at creating a complete set of industry variant designates, each linked to a specific industry, or profession, or being, or thing.

Each of the five topologies depicted by FIGS. 11-15 enables an e-market to establish an online geocommodity umbrella brand system to cover the entire global market by having a designated GeoCommodity Umbrella Brand (domain) for each of its market segment, in the form like “USPatent.com”, “USFinance.com”, “USComputers.com” and “USFood.com”, etc.

A GCUB at national or industrial level could be carried down to lower common identifier, such as the name of a state, a city, a county or an area, or the name of a sub-industry, etc., to identify a sub class of products or services, things or beings, such like “USNYPatent.com”. A GCUB could be further carried down to the lowest common identifier, such as the name of a specific product or service, thing or being, to identify a company, a business unit, a product, a service, a business process or a certain aspect of a thing or being that is of interest in the market (see FIG. 11).

Each GCUB is mapped to an equivalent GCIC for back end computerized business process (see FIG. 21). FIG. 21 depicts a general method of mapping (Unified Global Online GeoCommodity Umbrella Brands (UGOGCUB) to GeoCommodity Identification System (GCIS). UGOGCUB points both a CountryNameIndustryName topology based and an IndustryNameCountryName topology based brands, but both of the brands will point to the same GCIS code, 23.

Each GCUB represents a closely related business group with its own website and management body, and uses its own expertise to design and develop its own group strategies and membership polices concerning how its website, the e-market segment, should be operated, and how member firms should be introduced to a worldwide clientele by using their own home-made rating system.

The businesses in the same geographic location and industrial field tend to share many common characteristics. Traditionally, they are fierce competitors. But today, they can, and they should, be the best allies in the global e-marketplace.

In an overcrowded City X, people often elbow each other out of their way to get around. When two people from City X meet in another country, however, they may immediately become partners because they face the same challenges, and they can do things better if they team up with each other.

The people in another country may refer to them not by their personal names, such as “Tom”, or “Jack”, but simply by their group name “the two Americans”, or “the two City X'ers” because their shared characteristics and common background. In certain circumstances, that is indeed a more appropriate way to identify them.

The same is true in an efficient global e-market. The businesses that fall in the same GCUB group should team together to promote a common strategic goal in the global e-market. Banks and financial institutions flock to the Wall Street for businesses. They compete with each other. But they also depend on each other to create the kind of synergy and economies of scale that makes the Wall Street a preferred place for getting things done. The advantages by far outweigh the disadvantages. The GCUB groups are the basic organizational building blocks in the System of E-Market Management and Global Online Cross Industry Business Integration, and provide a central role in organizing member firms world over, with all kinds of industry backgrounds, into an orderly multi-tier networked structure.

One of the functions that a GCUB provides is to design and develop a set of measures to measure the performance of each of its member firms. Since a global e-market could potentially have so many trading participants, most participants do not know most others in the market, it is necessary that we create a mechanism for participants to measure the commodity quality.

The difficulty that we have experienced in obtaining reliable investment information in the financial market tells us that we have to find a new way to do things. It is particularly so because the potential product varieties of an e-market are much greater than what the financial market could offer. We have to find a much more effective, economical, and reliable way of rating geocommodities in an e-market.

One thing that could be of help is the recruiting practice of college graduates. Each year, our education system produces millions of new college graduates. Companies recruit those graduates mostly based on just one piece of information: the school report.

A school report consists of grades and comments made by teachers and professors and of records of extra curricular activities in which a student was involved that further reveals a student's acceptance by his or her peer classmates or schoolmates. The teacher, professors and the peer classmates or schoolmates are the ones that are best positioned to tell a student's capabilities and personalities. Those are the most credible information sources that a recruiter could have.

In a global marketplace, the ones that are best positioned to rate a company and its commodities are the industry peers that are located in the same geographic area. Negative rating always hurts, however. What a geocommodity group should do is to set up same objective benchmarks against which the performance of each group member will be measured up.

The performance of the geocommodity group itself, in turn, will be measured up by the e-market. The first letter of two-digit rating code is used to rate the performance of a geocommodity group. The second letter of the two-digit rating code is used to rate the performance of a specific member firm. When the trustworthiness of the geocommodity group is put in question, its rating on the member firm will be discounted accordingly. So, it is of vital importance that every member in a group to do its best to promote and protect the group's commercial image: the brand.

The present invention further provides an ownership sharing and management delegation model that aligns the interests of all participants.

The ownership of the founder, preferably, is relatively fixed, and shall not be more than one of third of the organization. The ownerships of participating member firms, including the managing company, are preferably earned based on their performance and responsibilities and that are going to be diluted in each calendar year when new shares are issued to award active contributors.

The equity structure shall preferably be a permanent evolving process in which the active members' shares increase while the less active members' shares decrease to promote the interests of those who have really contributed, and to cultivate a sense of fairness.

The Ownership and Profit Sharing Model further separates ownerships with management responsibilities, preferably, at all different levels of the organizational hierarchy, to allow the delegation of management responsibilities to the best candidates possible through a permanently evolving selection process.

The role of the e-market is pretty much that of a business enabler. It sets up the platforms and guidelines. The kinds of shows that each platform will stage and how they will be staged are up to the “Web Master”, the management team, to decide.

Preferably, the advisory board of a GCUB shall consist of members largely from the most active participating companies in the group. The board selects the managing company and decides on key policy issues, including how to introduce its member firms to a worldwide clientele by using a credit rating system that is a must for companies world over to do business together. Another important decision is how it is going to promote its member firms' marketability by offering a “group insurance policy” that assures clients that (some) produces and services from this group will be delivered on time and will perform as specified.

Each GCUB group's performance can, in turn, be measured by a credit rating system at a higher-level GCUB or at the e-market and be reflected by the first letter of a two-digits rating code. The second letter of the two-digit rating code is used by GCUB groups to rate the performance of individual member firm within a GCUB.

The advisory board of the e-market or a supply network, in turn, preferably consists of members largely come from the most active GCUBs. The board will select and compose the management team and decides on major policy issues.

The present invention further provides a “Business Standardization and Specialization Model” that breaks business tasks into the smallest process units possible and standardizes and specializes business processes to allow business collaborations at its simplest and most effective format with high transparency, immediate results, and tight control.

Success is a moving target. To prevent the unexpected from happening, we need to determine exactly what we are supposed to do and do it quickly. Piece by piece, we can do a lot, and we do it in a more secured and effective fashion.

Many business leaders are concerned about the pending global convergence, because that will inevitably expose their businesses to increased competition. Yet, like the industry revolution that reduced the need for farmers but created quality job opportunities in the industry sector, e-commerce will open up new frontier through business specialization. And specialization should go hand in hand with standardization to achieve economics of scale and operational efficiency.

In current commodity or industry classification coding systems, there is difficulty in finding terms for some basic products and services. “Patent”, for example, is not a separate service item in the NAICS coding system. Even with the more ambitious UNSPSC coding system, which was created with the goal to facilitate electronic commerce, “patent” is just a part of a broader category specified as “Patent or trademark or copyright law.”

Patent could be for all kinds of scientific subjects, biology, computer, telecommunication, automation device, etc. Patent could relate to a number of different practices as well. With patent application practice, for example, it could be further differentiated into more specific disciplines, such as technical evaluation, research, drafting, editing and translation, if it needs to be filled internationally. Each of those items is a subject of business specialization.

To achieve that, the “Business Specialization and Standardization Model” provides a 53-digit character string, with a multi-dimension information string architecture, to specify each commodity by its origin, GCIC, Firm, rating for the rating agency (such as A), rating for the commodity (such as A), V (for variant, such as “2” to indicate that commodity serves the following specified area and the quantity quoted is for weekly consumption), serving area (such as “US0000” for USA nationwide), serving industry or field (such as financial industry), unit quantity (such as “120” for 200 hours per week), price (such as “2500” for hourly rate of $50), and first delivery date (such as “20020705” for Jul. 5, 2002).

FIG. 26 depicts an online business specification code. The 6-digit GCIS Zip Code 21 defines a specific geographic location (such as “USNYNY” for the City of New York) with the first two letters designating a country, the next two letters designating a state, the last two letters designating a city, or country, or area. The default is “000000” for anywhere in the world.

A one-digit number 39 indicates which industry/commodity classification standard is used, with default 0 indicating the using of UNSPSC.

The 10-digit GCIS Commodity Code 22 specifies a commodity. The first eight digits matches the UNSPSC's 8-digit code string, the longest on the market, the last two letters are GCIS reserved space to be used by respective industry groups to designate new products and services, and to further differentiate their commodities (such as “81110000000” for computer services with UNSPSC standard).

In addition, the 2-digit company abbreviation 40 designates a company, the one-digit big “R” 41 reveals the rating of performance of the rating agency that rates the performance of the targeting community, and the one-digit small “r” 42 reveals the rating of the performance of the targeting community or commodity by the rating agency. A score variant of 1-9 could indicate the marketability of the product. The measures used to evaluate a product or service shall be decided by the decision making body of a specific GeoIndustry group.

Furthermore, the one-digit numeric variant 43 designates a numeric number, with an even number indicating that the commodity serves the following defined area (44, below), and an odd number indicating that the commodity does not serve the following defined area (44, below). “0-1” indicates that quantity quoted is for daily shipment, “2-3” indicates that quantity quoted is for weekly shipment, “4-5” indicates that quantity quoted is for bi-weekly shipment, “6-7” indicates that quantity quoted is for monthly shipment, “8-9” indicates that quantity quoted is for quarterly shipment.

GCIS Zip Code 44 is a 6-digit code that specifies the area that the commodity serves or does not serve, depending on the even or odd number value of 43. The 10-digit GCIS Commodity Code 45 specifies the service's targeting industry.

The 3-digit and 2-dimension code 46 specifies the quantity available for the specified period of time. The first number indicates the unit number with 0 for “1”, 1 for “in 10”, 2 for “in 100”, 3 for “in 1000”, etc. For example, 587 stands for 8,700,000.

The 4-digit code 47 is used to specify unit cost in US Dollars. The first number indicates the unit number with 1 for “0.00”, 2 for “0.0”, 3 for “0”, 4 for “10”, 5 for “100”, etc. For example, 1999 stands for “$9.99”, and 4999 stands for “$9,990”. The 8-digit code 48 indicates the first delivery date.

Specialization and standardization were cornerstones in the industry revolution. In e-commerce, it was the soul. Without it, people throughout the world cannot work with each other. With it, we will be able not only to streamline our business procedures but also to bring our product and service standards to a higher level.

Just as a cup for the airline industry and a cup for home use are different and should use different materials in their production, and specifying the difference will help industries to differentiate their product mixture, specifying and standardizing such differences will institute a much higher quality standard, greatly encourage, and in many cases, force industries to further differentiate their product mixture and bring to the market unprecedented quality product and service varieties.

Specialization and standardization is also the foundation for optimal database structuring, a major challenge that every e-market operator has to face. Specialization and standardization screens out any ambiguity in identifying a commodity, a thing or being, so as to make the highest degree of grouping possible. Thus, we need to deal with the specific traits or characteristics of the group only once to cover everyone in the group, allowing the most concise database structuring.

Specialization and standardization shall start at the front end where software application will transform and/or translate any form of commodity information worldwide and cross industry into GOGCSC universal format. For example, currency shall be translated into US dollars, and the date shall be translated into year/month/date format.

All the information thus collected on a specific geocommodity shall be encapsulated and stored in a geocommodity object as property values. Geocommodity objects are the most basic and by far the largest object group in the system and should be kept in the leanest fashion possible.

Each object has methods to call on other objects for related information and processing capabilities. For example, the geocommodity may call the export object of the country that is not activated until a specific request is received, to see if there is any restriction on exporting the commodity to a certain country.

The information system has replications in various regional processing centers around the world. Most of the replications are localized small versions of the system that is sufficient to run most of the local jobs while also linked to major processing centers for jobs that they can not process locally.

The standardization of data feeds, the encapsulation of specific information within each specific object, the ability to call other related objects for additional information and processing capabilities, and the localization of information processing will greatly reduce the data load in the system and make massive and efficient data searching or data mining possible.

The development of an e-market is an evolving process. Initially, an e-market may cover just a number of strategic areas, say 20 strategic countries or cities. The UNSPSC now has over 11,000 codes, supposedly covering any product or service on the planet. Multiply UNSPSC codes with 20 geographic areas codes to reach 440,000 geocommodity codes (11,000×20=440,000). GOGCSC adds one more dimension to the Geocommodity Code System to bring the total number of GOGCSCs to 193,600,000,000. Initially, however, most of them may not be activated or utilized yet.

A personal computer today is more powerful than the fastest computer fifteen years ago. The fastest computer today is capable of 35,600,000,000,000 mathematical operations per second, power enough to support effective GOGCSC computation. The huddle really lays in the software system design, more specifically in the database structuring.

What is claimed is:

1. A system of e-market management and cross industry business integration that cuts across divisional-boundaries between and among different business units of a single diversified company, and/or between and among different corporations, and/or between and among different industries, and/or between and among different nations or regions from a business and information management perspective, comprising:
a processor;
means for specifying any type of product or service in any place in the world in a set of uniformed formats to identify every detail of an extremely complex global economy;
means for establishing a unified on-line interface between real world users and the processor by following the same format logics of said means for specifying and using real world names to form a unified on-line address to cover every product or service, thing or being, in a specific country or region, and/or in a specific industry or sub-industry;
means for breaking business tasks into their smallest business processes to allow business collaborations, sharply targeted data search and deal match-making, efficient database structuring and to institute a higher product and service standard;
means for rating the performance of all participants based on certain objective criteria;
means for aligning the interests of all participants by allocating equity shares to members based on their performance and for delegating management responsibilities to candidates through a permanently evolving selection process;
means for allowing project oriented business collaborations among all networked participants with high transparency, immediate results and tight control, each participant remains its own boss, while also being able to collaborate with others in any field that makes strategic sense;
multi-dimension information string architecture for accurately defining each geocommodity object to reduce unnecessary data traffics and allow effective data searching and processing; and
object oriented information management model that treats every entity or sub-entity as an object, that has replications in various regional processing centers around the world.
